(19) United States
(12) Patent Application Publication
(10) Pub. No.: US 2013/0035187 A1
(43) Pub. Date: Feb. 7, 2013

(54) MOTOR VEHICLE WITH BELT DRIVE AND PLANETARY GEAR TRAIN BETWEEN COMBUSTION ENGINE AND ELECTRIC MACHINE

(71) Applicants: BASTIAN GEBHARD, Munchen (DE); CHRISTIAN DUMANSKI, Plesching-Steyregg (AT)

(72) Inventors: BASTIAN GEBHARD, Munchen (DE); CHRISTIAN DUMANSKI, Plesching-Steyregg (AT)

(73) Assignees: Miba Sinter Austria GmbH, Laakirchen (AT); Audi AG, Ingolstadt (DE)

(21) Appl. No.: 13/363,001

(22) Filed: Jan. 31, 2012

(30) Foreign Application Priority Data
Feb. 1, 2011 (DE) 10 2011 010 091.1

(51) Int. Cl. F16H 3/72

(52) U.S. Cl. 475/5; 180/65.22; 903/902

(57) ABSTRACT

In a motor vehicle, a combustion engine and electric machine are coupled with each other by a belt drive having a pulley and by a planetary gear train. The pulley is connected with a rotatable element, e.g. the sun gear of the planetary gear train. A second rotatable element, e.g. the ring gear of the planetary gear train, is connected with a brake disk. The brake disk extends radially farther outwardly than the pulley. In this way, the brake, for example two brake elements with a brake caliper support and brake shoes, can be arranged outside the pulley, resulting in small dimensions of the planetary gear train with the pulley.

### CROSS-REFERENCES TO RELATED APPLICATIONS

This application claims the priority of German Patent Application, Serial No. 10 2011 010 091.1, filed Feb. 1, 2011, pursuant to 35 U.S.C. 119(a)-(d), the content of which is incorporated herein by reference in its entirety as if fully set forth herein.

### BACKGROUND OF THE INVENTION

The present invention relates to a motor vehicle with a combustion engine and an electric machine.

The following discussion of related art is provided to assist the reader in understanding the advantages of the invention, and is not to be construed as an admission that this related art is prior art to this invention.

Drive systems for driving auxiliary units of a combustion engine are known. Auxiliary units may be, for example, the generator, i.e. an electric machine, or an air-conditioning compressor.

In conventional systems, a ring gear of a planetary gear train can freely rotate, but can also be locked with a brake device, e.g. a brake disk, wherein the brake disk is integrated into the outer peripheral surface of the ring gear like a radial flange. Brake shoes are positioned at a significant distance from the pulley, necessitating the entire assembly with a planetary gear train to have large dimensions in the axial direction.

It would therefore be desirable and advantageous to obviate prior art shortcomings and to provide an improved assembly of a planetary gear train and pulley having a relatively compact form.

### SUMMARY OF THE INVENTION

According to one aspect of the present invention, a motor vehicle includes a combustion engine, an electric machine, a belt drive having a pulley, a brake disk forming part of a disk brake on the combustion engine, said brake disk extending farther radially outwardly than the pulley, and a planetary gear train coupling the electric machine with the combustion engine, said planetary gear train having a first element connected to the pulley for rotation about a rotation axis, and a second element connected with the brake disk and rotating about the rotation axis.

According to another advantageous feature of the present invention, a ring gear of the planetary gear train may be connected with the brake disk. This embodiment can be particularly easy constructed, because the ring gear is the radially outermost element of the planetary gear train, so that the brake disk (as a ring disk) can then be integrated on the ring gear, also like a radial flange.

According to another advantageous feature of the present invention, the planet carrier (planetary gear land) of the planetary gear train may be coupled with a crankshaft of the combustion engine and a sun gear of the planetary gear train may be connected with the pulley, wherein additionally the sun gear and the planet carrier are coupled with each other via a freewheel or can be coupled with each other via a clutch. In this embodiment, the combustion engine can be particularly easily coupled with the electric machine by way of the planetary gear train and the pulley, without requiring that the rotation speeds have always a predetermined ratio. In particular, the electric machine may preferably overtake the combustion engine, so that the rotor of the electric machine can rotate at a greater rotation speed than the rotation speed of a crankshaft multiplied with the gear ratio of belt drive/planetary gear train.

According to another advantageous feature of the present invention, the brake disk may be braked by a brake element that is fixed in relation to the combustion engine of the motor vehicle, wherein in particular a caliper support may be affixed to the body, with the brake shoes being movable in the caliper support. Because the brake element is fixed in relation to the combustion engine, the ring gear can be particularly effectively locked with respect to the additional elements of the planetary gear train.

According to another advantageous feature of the present invention, the disk brake may have two brake elements which are offset with respect to one another by an angle between 135° and 225°, preferably between 175° and 185° (in relation to the rotation axis of the elements of the planetary gear train). The positions of the two brakes advantageously meet the requirement not to interfere with the path of the belt in an axially similar position relative to the belt and not to introduce significant radial forces into the bearings during simultaneous actuation. In addition, these positions suppress tumbling movements of the brake disk.

According to another advantageous feature of the present invention, the disk brake may be controlled electromechanically, electro-hydraulically, electromagnetically, hydraulically or mechanically or with a combination of these types of controls. Therefore, those elements may be selected as brake elements which are particularly well-suited for locking the ring gear and/or which are cost-effective and/or space-saving.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of an assembly implemented in a motor vehicle according to the present invention,

FIG. 2 is a radial cross-section of the assembly of FIG. 1,

FIG. 3 is a perspective view on the assembly according to the present invention with brake calipers arranged on a component of the combustion engine, and

FIG. 4 is a radial cross-section of a detail of the assembly with the brake calipers of FIG. 3.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

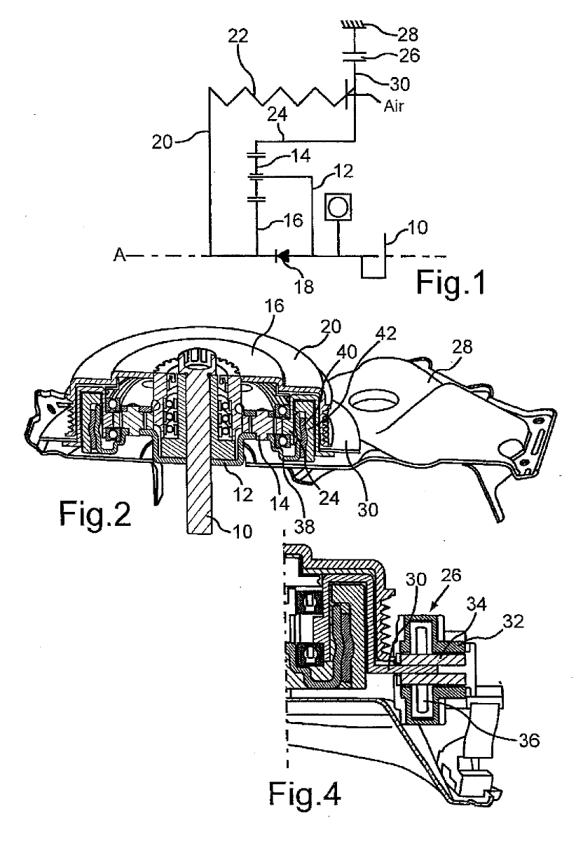

Turning now to the drawing, and in particular to FIG. 1, there is shown by way of a schematic diagram a crankshaft 10 of a combustion engine which is coupled with a planet carrier 12 of a planetary gear train, with the planet carrier 12 coupling several planetary gears 14 with each other. The planetary gears 14 roll on a sun gear 16 which is connected with a pulley 20 having a radially outward profile 22 configured for engagement with a belt of a belt drive. The sun gear 16 and the planet carrier 12 are coupled with one another by a freewheel 18 or clutch. An (unillustrated) electric machine, e.g. for starting the combustion engine with the crankshaft 10, can be coupled by way of the belt drive. The electric machine can also operate in reverse as a generator. A ring gear 24 of the planetary gear train can be locked with a brake on a body part 28 of the motor vehicle, wherein the brake engages radially farther outwardly with respect to a rotation axis A of the elements of the planetary gear train (sun gear 16, planet carrier 12, ring gear 24) than the pulley 20. In the present example, the brake is a disk brake: in particular, the ring gear 24 is connected with a ring-shaped disk 30, and the brake further includes brake elements 26 with a brake-caliper support 32, in which brake shoes 34 are supported which can be pushed by actuators 36 against the brake disk 30.

FIG. 2 shows the assembly of FIG. 1 in a radial cross-section. The assembly also includes a dynamic vibration absorber carrier 38 constructed from a metal plate which is coupled with the planet carrier 12. A steel ring 42 is coupled to the vibration absorber carrier 38 by way of a rubber ring 40, which absorbs and eliminates the vibrations from the crankshaft 10.

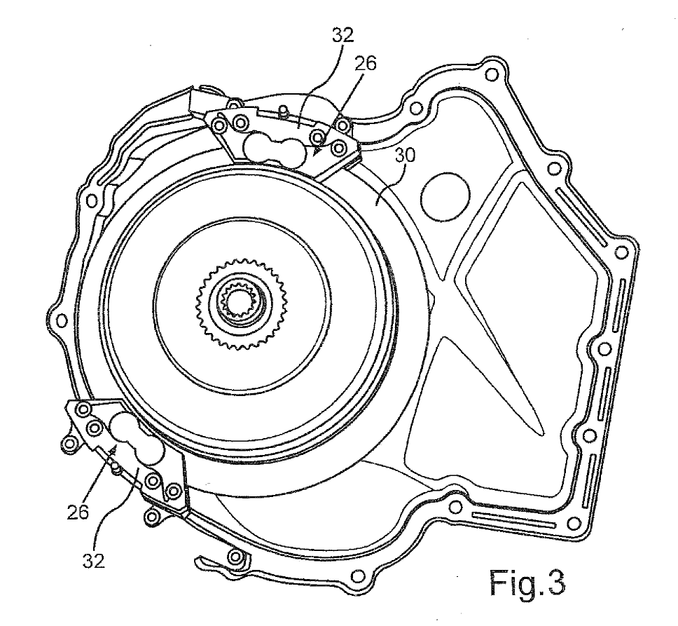

As shown more clearly in FIG. 3, in one embodiment, the brake disk includes two brake elements 26 which are offset in relation to the rotation axis A by 160°, i.e. by about 180°. A tumbling motion of the brake disk 30 and hence of the ring gear 24 can be effectively prevented by actuating these brake elements 26 simultaneously.

FIG. 4 shows a detail in radial cross-section of the assembly with the brake calipers 36.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle, comprising:
a combustion engine;
an electric machine;
a belt drive having a pulley;
a brake disk forming part of a disk brake on the combustion engine, said brake disk extending farther radially outwardly than the pulley; and
a planetary gear train coupling the electric machine with the combustion engine, said planetary gear train having a first element connected to the pulley for rotation about a rotation axis, and a second element connected with the brake disk and rotating about the rotation axis.

2. The motor vehicle of claim 1, wherein the planetary gear train comprises a ring gear connected with the brake disk.

3. The motor vehicle of claim 2, wherein the planetary gear train comprises a planet carrier coupled with a crankshaft of the combustion engine, and a sun gear connected with the pulley, wherein the sun gear and the planet carrier are coupled with one another by a freewheel.

4. The motor vehicle of claim 2, wherein the planetary gear train comprises a planet carrier coupled with a crankshaft of the combustion engine, and a sun gear connected with the pulley, wherein the sun gear and the planet carrier are coupleable with one another by a clutch.

5. The motor vehicle of claim 1, wherein the disk brake includes at least one brake element which is fixed in relation to the combustion engine of the motor vehicle, said brake element configured to brake the brake disk.

6. The motor vehicle of claim 5, wherein the disk brake includes two of said brake element disposed in offset relationship by between 135° and 225° with respect to the rotation axis.

7. The motor vehicle of claim 5, wherein the disk brake includes two of said brake element disposed in offset relationship by between 175° and 185° with respect to the rotation axis.

8. The motor vehicle of claim 1, wherein the disk brake is configured for actuation selected from the group consisting of electromechanical actuation, electro-hydraulic actuation, electromagnetic actuation, hydraulic actuation and mechanical actuation.
